(19) United States
(12) Patent Application Publication
(10) Pub. No.: US 2013/0093863 A1
(43) Pub. Date: Apr. 18, 2013

(54) LIQUID CRYSTAL PANEL OF 3D TV AND SHUTTER GLASSES

(71) Applicants: Hung-Lung Hou, Shenzhen (CN); Chengming He, Shenzhen (CN)

(72) Inventors: Hung-Lung Hou, Shenzhen (CN); Chengming He, Shenzhen (CN)

(73) Assignee: SHENZHEN CHINA STAR OPTOELECTRONICS TECHNOLOGY CO., LTD., SHENZHEN (CN)

(21) Appl. No.: 13/375,431

(22) PCT Filed: Oct. 21, 2011
(86) PCT No.: PCT/CN11/81104

§ 371 Date: Nov. 30, 2011

(30) Foreign Application Priority Data
Oct. 18, 2011 (CN) 201110316984.0

(51) Int. Cl. H04N 13/04

(52) U.S. Cl. 348/54; 348/E13.075; 348/E13.026; 348/E13.036

(57) ABSTRACT

Disclosed is a liquid crystal panel of a 3D TV, and the liquid crystal panel is provided with a left eye frame signal watched by left eye, a first frame signal, a right eye frame signal watched by a right eye and a second frame signal for overlay displaying each frame of displays. The first frame signal is a left-right eyes frame signal watched by the left eye and the right eye simultaneously, and the second frame signal is a black signal. The present invention also relates to shutter glasses of a 3D TV. The liquid crystal panel of a 3D TV and the shutter glasses are capable of increasing the display brightness of the 3D TV.

### BACKGROUND OF THE INVENTION

1. Field of the Invention

The present invention generally relates to a LCD manufacture field, and more particularly to a liquid crystal panel of a 3D TV and shutter glasses for increasing the display brightness.

2. Description of Prior Art

Gradually, the 3D TV becomes popular in the society. The main stream 3D technology is active shutter glasses skill. The display principle is shown in FIG. 1. With the cooperation of the liquid crystal panel signals and the shutter glasses, the left eye frame signal 1 enters into the left eye and the right eye frame signal 2 enters into the right eye to be constructed as a three-dimensional image in the brain. In case that pixels are divided into four sections and opened in sequence (1/4 gate electrodes opened, 2/4 gate electrodes opened, 3/4 gate electrodes opened and final gate electrodes opened) and meanwhile, each frame of displays are overlay displayed with four frame signals. The specific working flow is described below:

The 1/4 gate electrodes, the 2/4 gate electrodes, the 3/4 gate electrodes and the final gate electrodes are scanned in sequence from top to bottom. When scan for the particular gate electrodes (such as 1/4 gate electrodes) is completed, a reaction period T1 of the liquid crystal molecules twist shown in FIG. 1 exists for waiting the liquid crystal molecules twist is in position and completed to prevent the brightness errors. In the following period T2, the backlight of the pixels corresponding to the 1/4 gate electrodes can be turned on or turned off. The working principle is same for the other sections.

As the liquid crystal panel is provided with the left eye frame signal 1, the relevant left eye switch of the shutter glasses is turned on before the backlight in the first section is turned on and turned off after the backlight in the fourth section is turned off; as the liquid crystal panel is provided with the right eye frame signal 2, the relevant right eye switch of the shutter glasses is turned on before the backlight in the first section is turned on and turned off after the backlight in the fourth section is turned off; as the liquid crystal panel is provided with the black signal, the backlight in the all sections are turned off and the left eye switch and the right eye switch of the shutter glasses are also turned off.

A shown in FIG. 1, the turning on periods of the shutter glasses and the backlight of the liquid crystal panel are too short and easily causes an inadequate display brightness of the liquid crystal panel.

Consequently, there is a need to provide a liquid crystal panel of a 3D TV and shutter glasses to solve the existing problems of prior arts.

### SUMMARY OF THE INVENTION

An objective of the present invention is to provide a liquid crystal panel of a 3D TV and shutter glasses for increasing the display brightness for solving the inadequate display brightness issue of the liquid crystal panel because the turning on periods of the shutter glasses and the backlight of the liquid crystal panel are too short as watching the 3D images of the 3D TV of the prior arts.

For solving the aforesaid issue, the technical solution provided by the present invention is described below:

The present invention relates to a liquid crystal panel of a 3D TV, and the liquid crystal panel is provided with a left eye frame signal watched by left eye, a first frame signal, a right eye frame signal watched by a right eye and a second frame signal for overlay displaying each frame of displays, wherein the first frame signal is a left-right eyes frame signal watched by the left eye and the right eye simultaneously, and the second frame signal is a black signal; an output grey scale level of the left eye frame signal is smaller than an output grey scale level of the left-right eyes frame signal, and the output grey scale level of the left eye frame signal is smaller than an output grey scale level of the right eye frame signal; or the output grey scale level of the left eye frame signal is larger than the output grey scale level of the left-right eyes frame signal, and the output grey scale level of the left eye frame signal is larger than the output grey scale level of the right eye frame signal; an actual grey scale level of the left eye frame signal is determined by a backlight corresponding to the left eye frame signal and the output grey scale level of the left eye frame signal, and an actual grey scale level of the right eye frame signal is determined by a backlight corresponding to the right eye frame signal and the output grey scale level of the right eye frame signal, and an actual grey scale level of the left-right eyes frame signal is determined by a backlight corresponding to the left-right eyes frame signal and the output grey scale level of the left-right eyes frame signal; the backlights corresponding to the left eye frame signal, the right eye frame signal and the left-right eyes frame signal are determined by a driving current of the liquid crystal panel.

The present invention relates to a liquid crystal panel of a 3D TV, and the liquid crystal panel is provided with a left eye frame signal watched by left eye, a first frame signal, a right eye frame signal watched by a right eye and a second frame signal for overlay displaying each frame of displays, wherein the first frame signal is a left-right eyes frame signal watched by the left eye and the right eye simultaneously, and the second frame signal is a black signal.

In the liquid crystal panel of a 3D TV according to the present invention, an output grey scale level of the left-right eyes frame signal is smaller than an output grey scale level of the left eye frame signal, and the output grey scale level of the left-right eyes frame signal is smaller than an output grey scale level of the right eye frame signal.

In the liquid crystal panel of a 3D TV according to the present invention, an output grey scale level of the left-right eyes frame signal is smaller than an output grey scale level of the left eye frame signal, and the output grey scale level of the left-right eyes frame signal is equal to an output grey scale level of the right eye frame signal; or the output grey scale level of the left-right eyes frame signal is smaller than the output grey scale level of the right eye frame signal, and the output grey scale level of the left-right eyes frame signal is larger than the output grey scale level of the left eye frame signal.

In the liquid crystal panel of a 3D TV according to the present invention, an output grey scale level of the left eye frame signal is smaller than an output grey scale level of the left-right eyes frame signal, and the output grey scale level of the left eye frame signal is smaller than an output grey scale level of the right eye frame signal; or the output grey scale level of the left eye frame signal is larger than the output grey scale level of the left-right eyes frame signal, and the output grey scale level of the left eye frame signal is larger than the output grey scale level of the right eye frame signal.

In the liquid crystal panel of a 3D TV according to the present invention, an actual grey scale level of the left eye frame signal is determined by a backlight corresponding to the left eye frame signal and the output grey scale level of the left eye frame signal, and an actual grey scale level of the right eye frame signal is determined by a backlight corresponding to the right eye frame signal and the output grey scale level of the right eye frame signal, and an actual grey scale level of the left-right eyes frame signal is determined by a backlight corresponding to the left-right eyes frame signal and the output grey scale level of the left-right eyes frame signal.

The present invention also relates to shutter glasses of a 3D TV, comprising a left eye switch to control an entry of a left eye frame signal and a right eye switch to control an entry of a right eye frame signal, and the shutter glasses is passed through with the left eye frame signal watched by left eye, a first frame signal, the right eye frame signal watched by a right eye and a second frame signal for overlay displaying each frame of displays, wherein the first frame signal is a left-right eyes frame signal watched by the left eye and the right eye simultaneously, and the second frame signal is a black signal; both the left eye switch and the right eye switch of the shutter glasses are turned on when the shutter glasses is passed through with the left-right eyes frame signal; both the left eye switch and the right eye switch of the shutter glasses are turned off when the shutter glasses is passed through with the black signal.

In the shutter glasses of a 3D TV according to the present invention, an output grey scale level of the left-right eyes frame signal is smaller than an output grey scale level of the left eye frame signal, and the output grey scale level of the left-right eyes frame signal is smaller than an output grey scale level of the right eye frame signal.

In the shutter glasses of a 3D TV according to the present invention, an output grey scale level of the left-right eyes frame signal is smaller than an output grey scale level of the left eye frame signal, and the output grey scale level of the left-right eyes frame signal is equal to an output grey scale level of the right eye frame signal; or the output grey scale level of the left-right eyes frame signal is smaller than the output grey scale level of the right eye frame signal, and the output grey scale level of the left-right eyes frame signal is larger than the output grey scale level of the left eye frame signal.

In the shutter glasses of a 3D TV according to the present invention, an output grey scale level of the left eye frame signal is smaller than an output grey scale level of the left-right eyes frame signal, and the output grey scale level of the left eye frame signal is smaller than an output grey scale level of the right eye frame signal; or the output grey scale level of the left eye frame signal is larger than the output grey scale level of the left-right eyes frame signal, and the output grey scale level of the left eye frame signal is larger than the output grey scale level of the right eye frame signal.

In the shutter glasses of a 3D TV according to the present invention, an actual grey scale level of the left eye frame signal is determined by a backlight corresponding to the left eye frame signal and the output grey scale level of the left eye frame signal, and an actual grey scale level of the right eye frame signal is determined by a backlight corresponding to the right eye frame signal and the output grey scale level of the right eye frame signal, and an actual grey scale level of the left-right eyes frame signal is determined by a backlight corresponding to the left-right eyes frame signal and the output grey scale level of the left-right eyes frame signal.

The liquid crystal panel of a 3D TV and shutter glasses of the present invention is capable of increasing the display brightness of the 3D TV to prevent the drawback of inadequate display brightness of the liquid crystal panel because the turning on periods of the shutter glasses and the backlight of the liquid crystal panel are too short as watching the 3D images of the 3D TV of the prior arts.

For a better understanding of the aforementioned content of the present invention, preferable embodiments are illustrated in accordance with the attached figures for further explanation:

### BRIEF DESCRIPTION OF THE DRAWINGS

FIG. 1 depicts a working principle diagram of a liquid crystal panel of a 3D TV and shutter glasses according to the prior art;

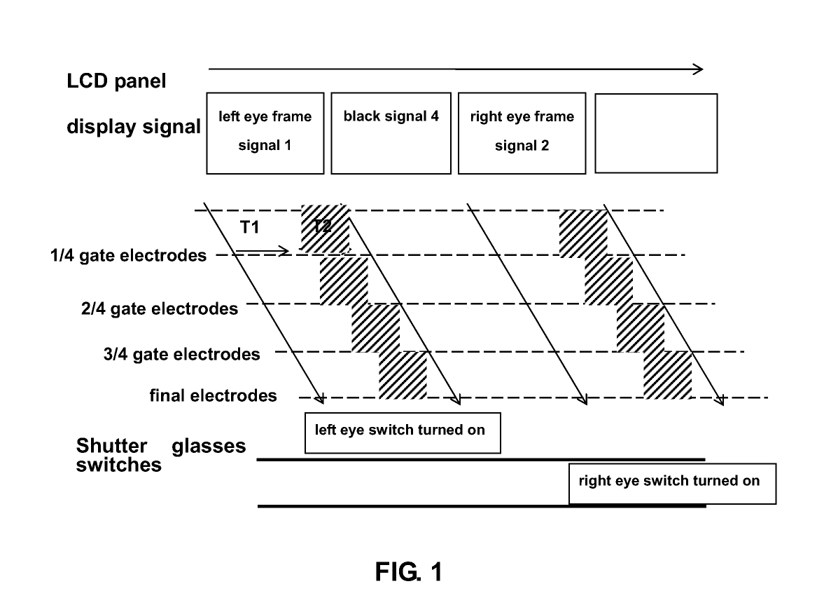

FIG. 2 depicts a working principle diagram of a liquid crystal panel of a 3D TV and shutter glasses according to the preferable embodiment of the present invention;

FIG. 3 depicts a comparison diagram of respective output grey scale levels of signals in the liquid crystal panel of a 3D TV and the shutter glasses according to respective preferable embodiments of the prior art and the present invention.

### DETAILED DESCRIPTION OF THE INVENTION

The following descriptions for the respective embodiments are specific embodiments capable of being implemented for illustrations of the present invention with referring to appended figures. For example, the terms of up, down, front, rear, left, right, interior, exterior, side, etcetera are merely directions of referring to appended figures. Therefore, the wordings of directions are employed for explaining and understanding the present invention but not limitations thereto.

In figures, the elements with similar structures are indicated by the same number.

The present invention relates to a liquid crystal panel of a 3D TV, and the liquid crystal panel is provided with a left eye frame signal 1 watched by left eye, a first frame signal, a right eye frame signal 2 watched by a right eye and a second frame signal for overlay displaying each frame of displays. According to the prior art, both the first frame signal and the second frame signal are black signals 4. In the present invention, the first frame signal is a left-right eyes frame signal 3 watched by the left eye and the right eye simultaneously and the second frame signal is a black signal 4. When the liquid crystal panel of the present invention is employed, as the liquid crystal panel is provided with the first frame signal, the relevant left eye switch and the right eye switch of the shutter glasses are turned on; the backlight corresponding to the left-right eyes frame signal 3 is turned on simultaneously when an output grey scale of the left-right eyes frame signal 3 is displayed. Therefore, the turning on periods of the shutter glasses and the backlight of the liquid crystal panel are raised in comparison with the 3D TV of the prior art to recover the drawback of inadequate display brightness of the liquid crystal panel.

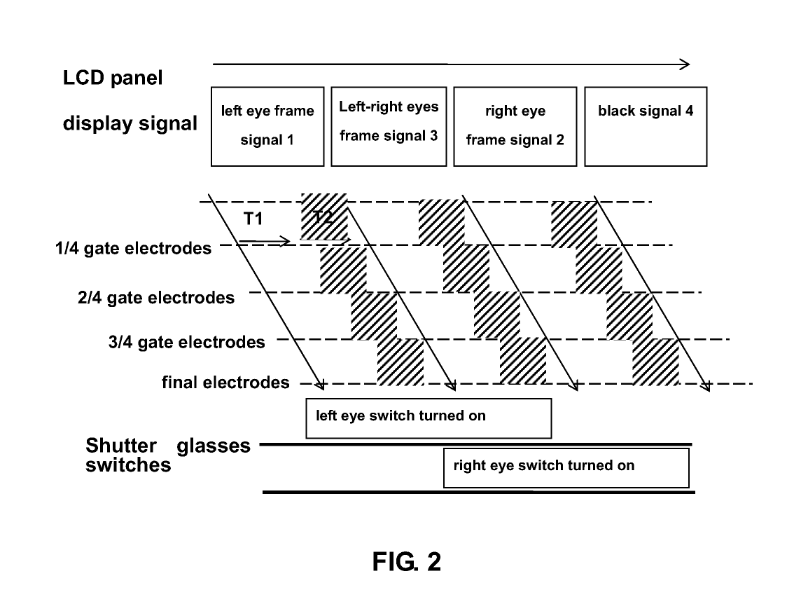

The first preferable embodiment of a liquid crystal panel of a 3D TV according to the present invention is shown in FIG. 2. FIG. 2 depicts a working principle diagram of the liquid crystal panel of the 3D TV and the shutter glasses according to the preferable embodiment of the present invention. An output grey scale level of the left-right eyes frame signal 3 is smaller than an output grey scale level of the left eye frame signal 1, and meanwhile, the output grey scale level of the left-right eyes frame signal 3 is smaller than an output grey scale level of the right eye frame signal 2. In this embodiment, the actual grey scale levels (the grey scale levels that the user watches through the shutter glasses) of the respective signals are equal to the output grey scale levels (the output provided to the liquid crystal panel without considering the grey scale levels of the backlights). Due to the existence of the left-right eyes frame signal 3, the output grey scale level of the left eye frame signal 1 can be diminished and the output grey scale level of the right eye frame signal 2 also can be diminished in the mean time. Accordingly, the differences of the grey scale conversions of the liquid crystal molecules are diminished, too. The reaction period T1 of the liquid crystal molecules twist as the left eye frame signal 1 is switched to the left-right eyes frame signal 3 and as the left-right eyes frame signal 3 is switched to the right eye frame signal 2 can be shortened. Accordingly, the turning on period T2 of the corresponding backlight can be raised to further increase the display brightness of the 3D TV.

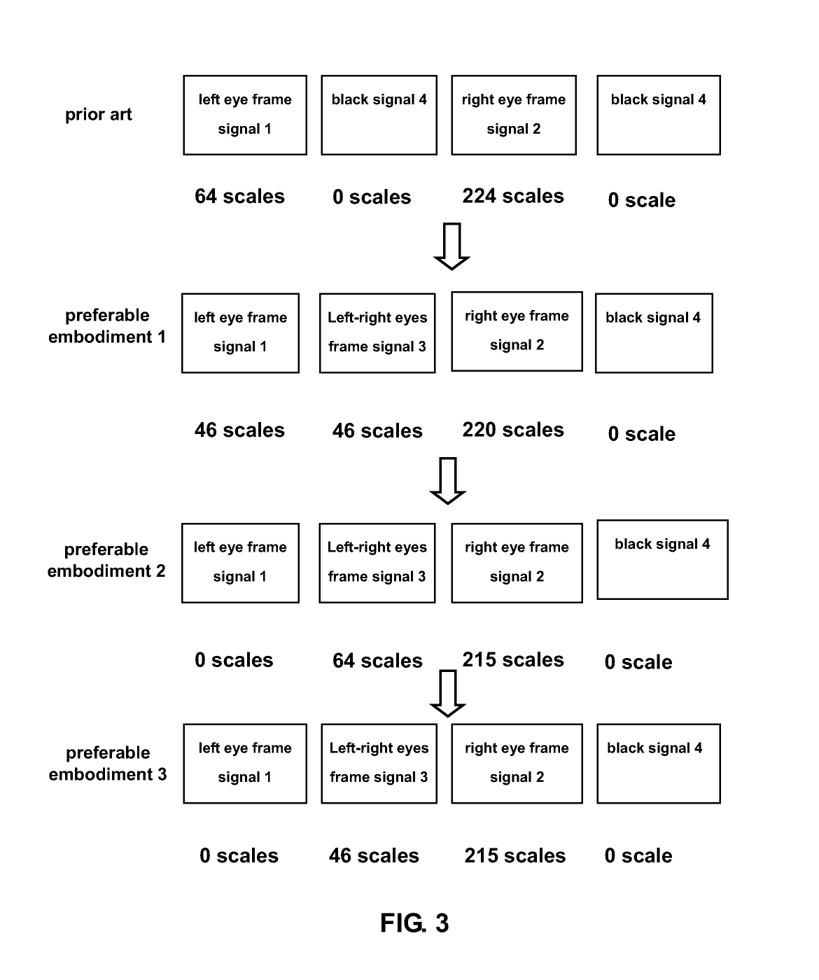

In the second preferable embodiment of the liquid crystal panel of the 3D TV according to the present invention, the output grey scale level of the additional left-right eyes frame signal 3 is smaller than the output grey scale level of the right eye frame signal 2, and the output grey scale level of the left-right eyes frame signal 3 is equal to the output grey scale level of the left eye frame signal 1. When the output grey scale level of the left eye frame signal 1 is smaller than the output grey scale level of the right eye frame signal 2, the output grey scale level of the left-right eyes frame signal 3 can be equal to the output grey scale level of the left eye frame signal 1. As shown in FIG. 3, (FIG. 3 depicts a comparison diagram of respective output grey scale levels of signals in the liquid crystal panel of a 3D TV and the shutter glasses according to respective preferable embodiments of the prior art and the present invention), in the first preferable solution, the output grey scale level of the left eye frame signal 1 is diminished from 64 scales to 46 scales. The output grey scale level of the left-right eyes frame signal 3 is also 46 scales. The output grey scale level of the right eye frame signal 2 is diminished from 224 scales to 220 scales (the brightness of the 46 scale signal is a half of the brightness of the 64 scale signal, and the brightness of the 220 scale signal is the brightness of the 224 scale signal subtracting the brightness of the 46 scale signal). Therefore, as the left eye frame signal 1 is switched to the left-right eyes frame signal 3, the grey scale conversions of the liquid crystal molecules are unnecessary and the reaction period T1 of the liquid crystal molecules twist can be shortened in minimum. Accordingly, the turning on period T2 of the corresponding backlight can be raised. Grounding upon the first preferable embodiment, the display brightness of the 3D TV can be increased, further.

Similarly, when the output grey scale level of the right eye frame signal 2 is smaller than the output grey scale level of the left eye frame signal 1, the output grey scale level of the left-right eyes frame signal 3 can be equal to the output grey scale level of the right eye frame signal 2. As aforesaid theory, as the left-right eyes frame signal 3 is switched to the right eye frame signal 2, the grey scale conversions of the liquid crystal molecules are unnecessary and the reaction period T1 of the liquid crystal molecules twist can be shortened in minimum. Accordingly, the turning on period T2 of the corresponding backlight can be raised to further increase the display brightness of the 3D TV. Grounding upon the first preferable embodiment, the display brightness of the 3D TV can be increased, further.

In the third preferable embodiment of the liquid crystal panel of the 3D TV according to the present invention, the output grey scale level of the additional left-right eyes frame signal 3 is larger than the output grey scale level of the left eye frame signal 1, and the output grey scale level of the left-right eyes frame signal 3 is smaller than the output grey scale level of the right eye frame signal 2. When the output grey scale level of the left eye frame signal 1 is smaller than the output grey scale level of the right eye frame signal 2, the output grey scale level of the left-right eyes frame signal 3 can be larger than the output grey scale level of the left eye frame signal 1. As shown in FIG. 3, (FIG. 3 depicts a comparison diagram of respective output grey scale levels of signals in the liquid crystal panel of a 3D TV and the shutter glasses according to respective preferable embodiments of the prior art and the present invention), in the second preferable solution, the output grey scale level of the left eye frame signal 1 is diminished from 64 scales to 0 scales. The output grey scale level of the left-right eyes frame signal 3 is changed from 0 scales to 64 scales. The output grey scale level of the right eye frame signal 2 is diminished from 224 scales to 215 scales (the brightness of the 215 scale signal is the brightness of the 224 scale signal subtracting the brightness of the 64 scale signal). Therefore, as the left-right eyes frame signal 3 is switched to the right eye frame signal 2, the grey scale conversions of the liquid crystal molecules can be diminished (becoming smallest as the output grey scale level of the left eye frame signal 1 is diminished to 0 scales) and the reaction period T1 of the liquid crystal molecules twist can be shortened. Accordingly, the turning on period T2 of the corresponding backlight can be raised. Grounding upon the first preferable embodiment, the display brightness of the 3D TV can be increased, further.

Similarly, when the output grey scale level of the right eye frame signal 2 is smaller than the output grey scale level of the left eye frame signal 1, the output grey scale level of the left-right eyes frame signal 3 can be larger than the output grey scale level of the right eye frame signal 2. As aforesaid theory, as the left-right eyes frame signal 3 is switched to the right eye frame signal 2, the grey scale conversions of the liquid crystal molecules can be diminished (becoming smallest as the output grey scale level of the right eye frame signal 2 is diminished to 0 scales) and the reaction period T1 of the liquid crystal molecules twist can be shortened in minimum. Accordingly, the turning on period T2 of the corresponding backlight can be raised to further increase the display brightness of the 3D TV. Grounding upon the first preferable embodiment, the display brightness of the 3D TV can be increased, further.

In the fourth preferable embodiment of the liquid crystal panel of the 3D TV according to the present invention, an actual grey scale level of the left eye frame signal 1 is determined by a backlight corresponding to the left eye frame signal 1 and the output grey scale level of the left eye frame signal 1, and an actual grey scale level of the right eye frame signal 2 is determined by a backlight corresponding to the right eye frame signal 2 and the output grey scale level of the right eye frame signal 2, and an actual grey scale level of the left-right eyes frame signal 3 is determined by a backlight corresponding to the left-right eyes frame signal 3 and the output grey scale level of the left-right eyes frame signal 3. Therefore, except increasing the output grey scale level of the left-right eyes frame signal 3, the actual grey scale level of the left-right eyes frame signal 3 also can be increased by increasing the backlight corresponding to the left-right eyes frame signal 3. As shown in FIG. 3, (FIG. 3 depicts a comparison diagram of respective output grey scale levels of signals in the liquid crystal panel of a 3D TV and the shutter glasses according to respective preferable embodiments of the prior art and the present invention), in the third preferable solution, the output grey scale level of the left eye frame signal 1 is diminished from 64 scales to 0 scales. The output grey scale level of the left-right eyes frame signal 3 is changed from 0 scales to 46 scales. The output grey scale level of the right eye frame signal 2 is diminished from 224 scales to 215 scales (the brightness of the 215 scale signal is the brightness of the 224 scale signal subtracting the brightness of the 64 scale signal). The driving current of the liquid crystal panel is raised to increase the corresponding backlight brightness of the left-right eyes frame signal 3. In this embodiment, the corresponding backlight brightness of the left-right eyes frame signal 3 is raised twice of the original setting to make the actual grey scale level of the left-right eyes frame signal 3 becomes 64 scales. Similarly, the reaction period T1 of the liquid crystal molecules twist as the left eye frame signal 1 is switched to the left-right eyes frame signal 3 and as the left-right eyes frame signal 3 is switched to the right eye frame signal 2 can be shortened. Accordingly, the turning on period T2 of the corresponding backlight can be raised to further increase the display brightness of the 3D TV.

The present invention also relates to shutter glasses of a 3D TV, comprising a left eye switch to control an entry of a left eye frame signal and a right eye switch to control an entry of a right eye frame signal, and the shutter glasses is passed through with the left eye frame signal 1 watched by left eye, a first frame signal, the right eye frame signal 2 watched by a right eye and a second frame signal for overlay displaying each frame of displays. The first frame signal is a left-right eyes frame signal 3 watched by the left eye and the right eye simultaneously, and the second frame signal is a black signal; both the left eye switch and the right eye switch of the shutter glasses are turned on when the shutter glasses is passed through with the left-right eyes frame signal 3; both the left eye switch and the right eye switch of the shutter glasses are turned off when the shutter glasses is passed through with the black signal. For the shutter glasses of the present invention, the first frame signal is a left-right eyes frame signal 3 watched by the left eye and the right eye simultaneously. When the shutter glasses of the present invention is employed, as the liquid crystal panel is provided with the first frame signal, the relevant left eye switch and the right eye switch of the shutter glasses are turned on; the backlight corresponding to the left-right eyes frame signal 3 is turned on simultaneously when an output grey scale of the left-right eyes frame signal 3 is displayed. Therefore, the turning on periods of the shutter glasses and the backlight of the liquid crystal panel are raised in comparison with the 3D TV of the prior art to recover the drawback of inadequate display brightness of the liquid crystal panel.

In the first preferable embodiment of the shutter glasses according to the present invention, An output grey scale level of the left-right eyes frame signal 3 is smaller than an output grey scale level of the left eye frame signal 1 and the output grey scale level of the left-right eyes frame signal 3 is smaller than an output grey scale level of the right eye frame signal 2. The benefits and the effects of the first preferable embodiment of the shutter glasses according to the present invention is the same or similar to the aforementioned first preferable embodiment of the liquid crystal panel of the 3D TV according to the present invention. Please refer to the specific embodiment of the liquid crystal panel of the 3D TV for specific.

In the second preferable embodiment of the shutter glasses of the 3D TV according to the present invention, the output grey scale level of the left-right eyes frame signal 3 is smaller than the output grey scale level of the left eye frame signal 1, and the output grey scale level of the left-right eyes frame signal 3 is equal to the output grey scale level of the right eye frame signal 2; or the output grey scale level of the additional left-right eyes frame signal 3 is smaller than the output grey scale level of the right eye frame signal 2, and the output grey scale level of the left-right eyes frame signal 3 is equal to the output grey scale level of the left eye frame signal 1. The benefits and the effects of the second preferable embodiment of the shutter glasses according to the present invention is the same or similar to the aforementioned second preferable embodiment of the liquid crystal panel of the 3D TV according to the present invention. Please refer to the specific embodiment of the liquid crystal panel of the 3D TV for specific.

In the third preferable embodiment of the shutter glasses of the 3D TV according to the present invention, the output grey scale level of the left eye frame signal 1 is smaller than the output grey scale level of the left-right eyes frame signal 3, and the output grey scale level of the left-right eyes frame signal 3 is smaller than the output grey scale level of the right eye frame signal 2; or the output grey scale level of the left eye frame signal 1 is larger than the output grey scale level of the left-right eyes frame signal 3, and the output grey scale level of the left-right eyes frame signal 3 is larger than the output grey scale level of the right eye frame signal 2. The benefits and the effects of the second preferable embodiment of the shutter glasses according to the present invention is the same or similar to the aforementioned second preferable embodiment of the liquid crystal panel of the 3D TV according to the present invention. Please refer to the specific embodiment of the liquid crystal panel of the 3D TV for specific.

In the fourth preferable embodiment of the shutter glasses of the 3D TV according to the present invention, an actual grey scale level of the left eye frame signal 1 is determined by a backlight corresponding to the left eye frame signal 1 and the output grey scale level of the left eye frame signal 1, and an actual grey scale level of the right eye frame signal 2 is determined by a backlight corresponding to the right eye frame signal 2 and the output grey scale level of the right eye frame signal 2, and an actual grey scale level of the left-right eyes frame signal 3 is determined by a backlight corresponding to the left-right eyes frame signal 3 and the output grey scale level of the left-right eyes frame signal 3. Therefore, except increasing the output grey scale level of the left-right eyes frame signal 3, the actual grey scale level of the left-right eyes frame signal 3 also can be increased by increasing the backlight corresponding to the left-right eyes frame signal 3. The driving current of the liquid crystal panel is raised to increase the corresponding backlight brightness of the left-right eyes frame signal 3. The benefits and the effects of the second preferable embodiment of the shutter glasses according to the present invention is the same or similar to the aforementioned second preferable embodiment of the liquid crystal panel of the 3D TV according to the present invention. Please refer to the specific embodiment of the liquid crystal panel of the 3D TV for specific.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A liquid crystal panel of a 3D TV, and the liquid crystal panel is provided with a left eye frame signal watched by left eye, a first frame signal, a right eye frame signal watched by a right eye and a second frame signal for overlay displaying each frame of displays, characterized in that,
the first frame signal is a left-right eyes frame signal watched by the left eye and the right eye simultaneously, and the second frame signal is a black signal;
an output grey scale level of the left eye frame signal is smaller than an output grey scale level of the left-right eyes frame signal, and the output grey scale level of the left eye frame signal is smaller than an output grey scale level of the right eye frame signal; or
the output grey scale level of the left eye frame signal is larger than the output grey scale level of the left-right eyes frame signal, and the output grey scale level of the left eye frame signal is larger than the output grey scale level of the right eye frame signal;
an actual grey scale level of the left eye frame signal is determined by a backlight corresponding to the left eye frame signal and the output grey scale level of the left eye frame signal, and an actual grey scale level of the right eye frame signal is determined by a backlight corresponding to the right eye frame signal and the output grey scale level of the right eye frame signal, and an actual grey scale level of the left-right eyes frame signal is determined by a backlight corresponding to the left-right eyes frame signal and the output grey scale level of the left-right eyes frame signal;
the backlights corresponding to the left eye frame signal, the right eye frame signal and the left-right eyes frame signal are determined by a driving current of the liquid crystal panel.

2. A liquid crystal panel of a 3D TV, and the liquid crystal panel is provided with a left eye frame signal watched by left eye, a first frame signal, a right eye frame signal watched by a right eye and a second frame signal for overlay displaying each frame of displays, characterized in that,
the first frame signal is a left-right eyes frame signal watched by the left eye and the right eye simultaneously, and the second frame signal is a black signal.

3. The liquid crystal panel of a 3D TV according to claim 2, characterized in that an output grey scale level of the left-right eyes frame signal is smaller than an output grey scale level of the left eye frame signal, and the output grey scale level of the left-right eyes frame signal is smaller than an output grey scale level of the right eye frame signal.

4. The liquid crystal panel of a 3D TV according to claim 2, characterized in that an output grey scale level of the left-right eyes frame signal is smaller than an output grey scale level of the left eye frame signal, and the output grey scale level of the left-right eyes frame signal is equal to an output grey scale level of the right eye frame signal; or
the output grey scale level of the left-right eyes frame signal is smaller than the output grey scale level of the right eye frame signal, and the output grey scale level of the left-right eyes frame signal is larger than the output grey scale level of the left eye frame signal.

5. The liquid crystal panel of a 3D TV according to claim 2, characterized in that an output grey scale level of the left eye frame signal is smaller than an output grey scale level of the left-right eyes frame signal, and the output grey scale level of the left eye frame signal is smaller than an output grey scale level of the right eye frame signal; or
the output grey scale level of the left eye frame signal is larger than the output grey scale level of the left-right eyes frame signal, and the output grey scale level of the left eye frame signal is larger than the output grey scale level of the right eye frame signal.

6. The liquid crystal panel of a 3D TV according to claim 3, characterized in that an actual grey scale level of the left eye frame signal is determined by a backlight corresponding to the left eye frame signal and the output grey scale level of the left eye frame signal, and an actual grey scale level of the right eye frame signal is determined by a backlight corresponding to the right eye frame signal and the output grey scale level of the right eye frame signal, and an actual grey scale level of the left-right eyes frame signal is determined by a backlight corresponding to the left-right eyes frame signal and the output grey scale level of the left-right eyes frame signal.

7. The liquid crystal panel of a 3D TV according to claim 4, characterized in that an actual grey scale level of the left eye frame signal is determined by a backlight corresponding to the left eye frame signal and the output grey scale level of the left eye frame signal, and an actual grey scale level of the right eye frame signal is determined by a backlight corresponding to the right eye frame signal and the output grey scale level of the right eye frame signal, and an actual grey scale level of the left-right eyes frame signal is determined by a backlight corresponding to the left-right eyes frame signal and the output grey scale level of the left-right eyes frame signal.

8. The liquid crystal panel of a 3D TV according to claim 5, characterized in that an actual grey scale level of the left eye frame signal is determined by a backlight corresponding to the left eye frame signal and the output grey scale level of the left eye frame signal, and an actual grey scale level of the right eye frame signal is determined by a backlight corresponding to the right eye frame signal and the output grey scale level of the right eye frame signal, and an actual grey scale level of the left-right eyes frame signal is determined by a backlight corresponding to the left-right eyes frame signal and the output grey scale level of the left-right eyes frame signal.

9. Shutter glasses of a 3D TV, comprising a left eye switch to control an entry of a left eye frame signal and a right eye switch to control an entry of a right eye frame signal, and the shutter glasses is passed through with the left eye frame signal watched by left eye, a first frame signal, the right eye frame signal watched by a right eye and a second frame signal for overlay displaying each frame of displays, characterized in that,
the first frame signal is a left-right eyes frame signal watched by the left eye and the right eye simultaneously, and the second frame signal is a black signal; both the left eye switch and the right eye switch of the shutter glasses are turned on when the shutter glasses is passed through with the left-right eyes frame signal; both the left eye switch and the right eye switch of the shutter glasses are turned off when the shutter glasses is passed through with the black signal.

10. The shutter glasses of a 3D TV according to claim 9, characterized in that an output grey scale level of the left-right eyes frame signal is smaller than an output grey scale level of the left eye frame signal, and the output grey scale level of the left-right eyes frame signal is smaller than an output grey scale level of the right eye frame signal.

11. The shutter glasses of a 3D TV according to claim 9, characterized in that an output grey scale level of the left-right eyes frame signal is smaller than an output grey scale level of the left eye frame signal, and the output grey scale level of the left-right eyes frame signal is equal to an output grey scale level of the right eye frame signal; or
the output grey scale level of the left-right eyes frame signal is smaller than the output grey scale level of the right eye frame signal, and the output grey scale level of the left-right eyes frame signal is larger than the output grey scale level of the left eye frame signal.

12. The shutter glasses of a 3D TV according to claim 9, characterized in that an output grey scale level of the left eye frame signal is smaller than an output grey scale level of the left-right eyes frame signal, and the output grey scale level of the left eye frame signal is smaller than an output grey scale level of the right eye frame signal; or
the output grey scale level of the left eye frame signal is larger than the output grey scale level of the left-right eyes frame signal, and the output grey scale level of the left eye frame signal is larger than the output grey scale level of the right eye frame signal.

13. The shutter glasses of a 3D TV according to claim 10, characterized in that an actual grey scale level of the left eye frame signal is determined by a backlight corresponding to the left eye frame signal and the output grey scale level of the left eye frame signal, and an actual grey scale level of the right eye frame signal is determined by a backlight corresponding to the right eye frame signal and the output grey scale level of the right eye frame signal, and an actual grey scale level of the left-right eyes frame signal is determined by a backlight corresponding to the left-right eyes frame signal and the output grey scale level of the left-right eyes frame signal.

14. The shutter glasses of a 3D TV according to claim 11, characterized in that an actual grey scale level of the left eye frame signal is determined by a backlight corresponding to the left eye frame signal and the output grey scale level of the left eye frame signal, and an actual grey scale level of the right eye frame signal is determined by a backlight corresponding to the right eye frame signal and the output grey scale level of the right eye frame signal, and an actual grey scale level of the left-right eyes frame signal is determined by a backlight corresponding to the left-right eyes frame signal and the output grey scale level of the left-right eyes frame signal.

15. The shutter glasses of a 3D TV according to claim 12, characterized in that an actual grey scale level of the left eye frame signal is determined by a backlight corresponding to the left eye frame signal and the output grey scale level of the left eye frame signal, and an actual grey scale level of the right eye frame signal is determined by a backlight corresponding to the right eye frame signal and the output grey scale level of the right eye frame signal, and an actual grey scale level of the left-right eyes frame signal is determined by a backlight corresponding to the left-right eyes frame signal and the output grey scale level of the left-right eyes frame signal.
